(19) United States
(12) Patent Application Publication
(10) Pub. No.: US 2004/0025319 A1
(43) Pub. Date: Feb. 12, 2004

(54) Torque fastener and method of fastening

(76) Inventor: Raymond J. Murphy, Barrington Hills, IL (US)

Correspondence Address: MERONI + MERONI, P.O. BOX 309, BARRINGTON, IL, 60011, US

(21) Appl. No.: 10/637,227

(22) Filed: Aug. 8, 2003

Related U.S. Application Data
(60) Provisional application No. 60/402,513, filed on Aug. 9, 2002.

(51) Int. Cl. B23P 17/00

(52) U.S. Cl. 29/525.01

(57) ABSTRACT

A fastener with a torqued extension. The fastener comprises a handle having a first end and a second end and a shaft assembly connected to the second end and extending away from the second end. Additionally, an extension is rotatably connected between the handle and the shaft assembly wherein the extension rotates between a closed position and an open position to increase a torque force applied to the shaft assembly in the open position. A method of fastening comprising positioning a handle and a shaft and rotating an extension connected to the handle from a closed position to an open position; to apply a force to the extension in the open position to exert an increased torque to the shaft.

### REFERENCE TO PRIORITY DOCUMENT

The present invention claims priority, to the extent permitted by law, to U.S. Provisional Application No. 60/402,513 filed on Aug. 9, 2002.

### BACKGROUND OF THE INVENTION

The present invention relates to a fastener. In particular, the present invention relates to a fastener, such as a screwdriver, having a high torque extension.

Traditional screwdrivers maintain a standard torque through the handle and shaft. Due to the typical alignment of the screwdriver handle and the bit, it is often difficult for the user to apply sufficient torque on a workpiece such as the screw or socket. Or, the user may not apply the necessary torque to properly fasten the screw.

As demands for proper fastening and quality escalate, a need exists for increasing the torque generated by a fastening tool. The solution, however, must apply the increased torque in a convenient process. The solution must also apply a standard amount of torque. Accordingly, a need exists for applying a high torque application and a standard torque application. Thus, a need exists for applying different levels of torque by a tool easily manipulated by the user. The solution must provide a convenient mechanism between the high torque application and the standard torque application. The solution must also provide incorporating a minimum amount of parts which fit within a comfortable and ergonomic handle.

The prior art does not satisfy the needs and solutions required. Typical hand held screwdrivers provide a handle with a rear mounted device that pivots between the aligned position and a generally traverse position relative to the handle. Other screwdrivers provide a handle that pivots near the rear allowing for a generally traverse grip of the handle. These screwdrivers, though, do not allow the user to apply significant amounts of torque. Additionally, rear mounted devices do not provide a convenient method of application. Other prior art, such as U.S. Pat. No. 6,595,300, provide side handles for power tools. These handles, though, only provide stability to user and do not increase the torque applied by the tool.

### BRIEF DESCRIPTION OF THE DRAWINGS

FIG. 1 illustrates in a breakaway perspective view an embodiment of the present invention.

FIG. 2 illustrates in a perspective view an embodiment of the present invention.

FIG. 3 illustrates in side view an embodiment of the present invention.

### SUMMARY OF INVENTION

The present invention relates to a fastener. In particular, the present invention relates to a fastener, such as a screwdriver, having a high torque extension. The fastener comprises a handle having a first end and a second end and a shaft assembly connected to the second end which extends away from the second end. Additionally, an extension is rotatably connected between the handle and the shaft assembly wherein the extension rotates between a closed position and an open position to increase a torque force applied to the shaft assembly in the open position.

The present invention relates to a method of fastening. In the present invention, the user positions the handle and a shaft into the appropriate work area. Then, the user rotates the extension which is connected to the handle from a closed position to an open position. Next, the user applies force to the extension in the open position to exert an increased torque to the shaft.

An advantage of the present invention is a hand held fastener which applies increased torque and standard torque.

Another advantage of the present invention is a fastener which operates in an open position and a closed stowed position.

Another advantage of the present invention is a fastener which comfortably fits in the user's hands in the open position and the closed position.

### DETAILED DESCRIPTION OF THE INVENTION

As stated, the present invention relates to a fastener, such as a screwdriver, having a high torque extension which rotates from a closed position to an open position to apply an increase in torque in the open position.

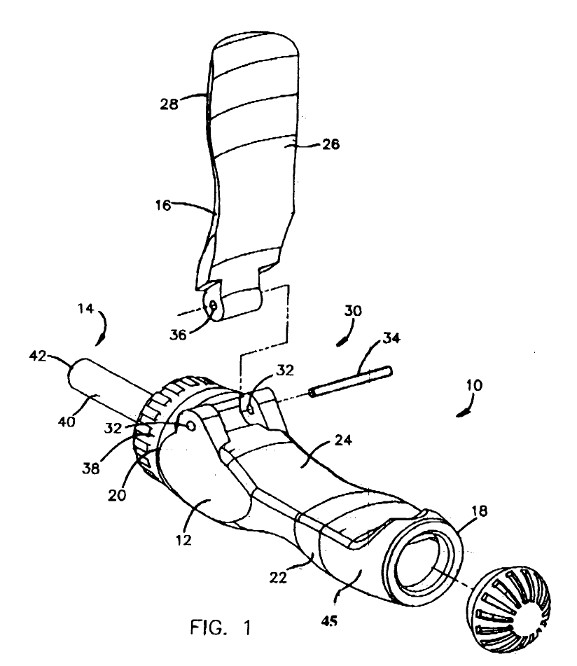

FIG. 1 illustrates a perspective breakaway view of an exemplary fastener tool generally shown as 10. The tool 10 comprises a handle 12, a shaft assembly generally shown as 14 and an extension 16.

The handle 12 comprises a first end 18, a second end 20 and a middle section 22 wherein the handle 12, made from a chemically resistant material, ergonomically fits comfortably into the user's hands. A closure, such as a threaded cap, seals the first end 18 while the second end 20 is sized and shaped to mate with the shaft assembly 14. The middle section 22 includes an indent portion 24 on a side of the handle 12 wherein the indent portion 24 is sized and shaped to match the configuration of the extension 16 as will be discussed. In an embodiment, the handle 12 may incorporate a storage chamber accessible by the cap wherein the storage chamber stores the accessories such as the bits.

As shown in FIG. 1, the extension 16 has a first side 26 and a second side 28. The first side 26 is sized and shaped to match the configuration of the indent portion 24 while the second side 28 is sized and shaped to match the configuration of the handle 12. The extension 16 rotatably connects to the handle 12 by a hinge assembly generally shown as 30.

The hinge assembly 30, located near the second end 20, comprises raised arms 32, a stop 33 and a pin 34 wherein the pin 34 connects to the extension 16 through an aperture 36. Accordingly, the extension 16 rotates about the hinge assembly 30.

The shaft assembly 14 comprises a cover 38, a shaft 40 and a shaft opening 42. The shaft assembly 22 connects to the handle 12 via the cover 38. As known in the art, the shaft opening 42 receives the appropriate accessory, such as a bit, for processing. The shaft opening 42 is sized to hold all standard accessories in accordance with ANSI and DIN standards. In an embodiment, the shaft opening 42 has a hexagonal opening which is magnetized to further assist the insertion of accessories into the shaft opening 42. The shaft 40 may include any output fastener such as a screwdriver blade, a socket or similar device for coupling the tool 10 to the accessory.

The shaft assembly 14 further incorporates three working positions of a ratcheting feature (forward, lock, reverse) wherein the forward position relates to clockwise movement of the shaft 40, the reverse position relates to counter clockwise movement of the shaft 40 and the lock position relates to either clockwise or counter clockwise movement of the shaft 40.

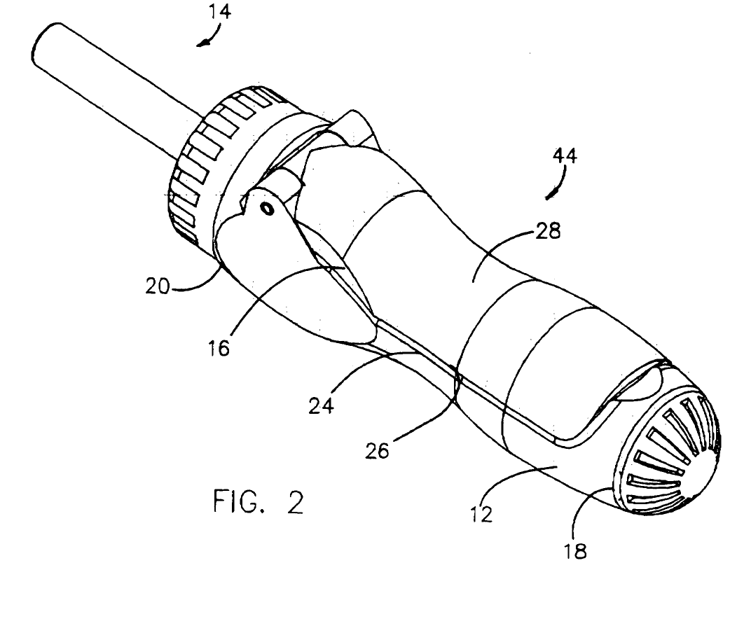

Turning to FIG. 2, the tool 10 is shown in the closed position generally shown as 44. Since the indent portion 24 and the first side 26 of the extension 16 are sized and shaped to configure together and the second side 28 of the extension 16 and the handle 12 are sized and shaped to configure together, the extension 16 becomes integral with the handle 12 in the closed position 44. Thus, when the indent portion 24 and the handle are curved shape, the first side 26 and the second side 28 will have matching curves respectively with the indent portion 24 and the handle 12. Accordingly, the extension 16 is positioned co-planar between the first end 18 and the second end 20 of the handle 12. In the closed position, the extension 16 and handle 12 form a continuous outer surface 45. Since the extension 16 fits into the indent portion 24 of the handle 12, the outer surface 45 comprises an annular circumference forming one body free of depressions or discontinuities. For ergonomic and aesthetic purpose, though, the outer surface 45 incorporates curves to assist in handling the tool 10. In the closed position 44, the tool 10 applies a standard torque to the shaft assembly 14.

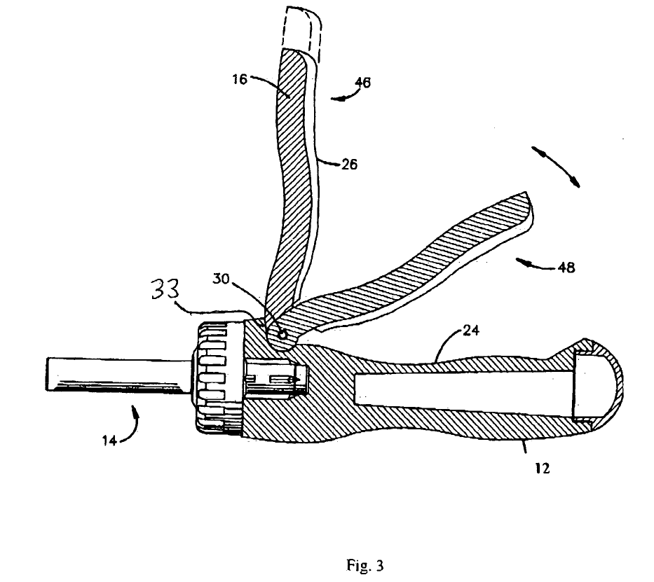

Turning to FIG. 3, the tool 10 is shown in the open position generally shown as 46. In the open position 46, the extension rotates away from the handle 12 wherein the extension 16 rotates to be perpendicular with the handle 12. A stop 33 prevents the extension 16 from rotating more than ninety degrees. In the open position 46, the indent portion 24 is ergonomically sized and shaped to provide a comfortable fit to the user. Additionally, the first side 26 of the extension 16 is ergonomically sized and shaped to provide a comfortable fit to the user. In an embodiment, the extension 16 is extendable providing an increased moment arm to provide an increased torque to the shaft assembly 14.

FIG. 3 also illustrates the tool 10 in the partially open position generally shown as 48. In the partially open position 48, the extension 16 is angularly positioned between the closed position 44 and the open position 46. In an embodiment, the hinge assembly 30 locks the extension 16 in a plurality of locations within the partially open position 48.

The present invention provides that the handle 12, the shaft assembly 14 and the extension 16 interact in the open position 44 to provide a higher torque to the shaft assembly 14. During use, the user chooses different torque operations presented by the tool 10. After the user inserts the appropriate accessory into the shaft opening 42, the user decides which working position of the shaft assembly 14 by selecting the forward, the lock or the reverse position depending on whether a clockwise or counter clockwise rotation is needed. The user then selects either the standard torque or the high torque operation.

In the standard torque operation, the user rotates the extension 16 into the closed position 44 as shown in FIG. 2 wherein the extension becomes part of the handle 12. While holding the handle 12, the user rotates the handle 12 to apply the standard torque to the shaft assembly 14. In the closed position 44, the user comfortably grasps the handle 12 since the handle 12 and the extension 16 form the continuous outer surface 45 which is free of any depressions or discontinuities.

To apply a higher torque to the shaft assembly 14, the user then rotates the extension 16 into the open position 46 as shown in FIG. 3. In the open position 46, the user holds the handle 12 with one hand and holds the extension 16 in the other hand. The user then rotates the extension 16 which applies more torque to the shaft assembly 14 since the extension 16 creates a moment arm. Accordingly, the hinge assembly 30 is positioned near the second end 20 of the handle 12. In the open position 46, the user easily grasps the handle 12 and extension 16 since the indent portion 24 of the handle 12 and the first side 26 of the extension 16 are ergonomically designed for a comfortable fit.

In an embodiment, the user may rotate the extension 16 into the plurality of locations in the partially open position 48 to apply different amounts of torque. The user may apply the partially open position 48 when the work area prevents rotating the extension 16 into the open position 46. Further, in an embodiment, the user extends the extension 16 to create a longer extension 16 which can apply a higher amount of torque.

The description of the invention is exemplary in nature, and thus, variations that do not depart from the gist of the invention are intended to be within the scope of the invention. Such variations are not to be regarded as departure from the spirit and scope of the invention.

I claim:

1. A fastener, comprising:
a handle, the handle having a first end and a second end;
a shaft assembly, the shaft assembly being connected to the second end and extending away from the second end; and
an extension, the extension being rotatably connected between the handle and the shaft assembly wherein the extension rotates between a closed position and an open position to increase a torque force applied to the shaft assembly in the open position.

2. The fastener according to claim 1, wherein the extension is positioned co-planar between the first end and the second end in the closed position.

3. The fastener according to claim 1, wherein the extension is perpendicularly positioned to the handle in the open position.

4. The fastener according to claim 3, further comprising a stop which prevents the extension from rotating beyond the perpendicular position.

5. The fastener according to claim 1, wherein the handle comprises an indent portion between the first end and the second end.

6. The fastener according to claim 5, wherein the extension is positioned in the indent portion in the closed position such that the extension and the handle form a continuous outer surface.

7. The fastener according to claim 6, wherein the continuous outer surface is an annular circumference.

8. The fastener according to claim 6, the continuous outer surface is free from discontinuities.

9. The fastener according to claim 1, further comprising a hinge assembly which rotatably connects the extension to the handle.

10. The fastener according to claim 9, wherein the hinge assembly is segmented to allow for at least one partially open position.

11. A fastener, comprising:
a handle, the handle having a first end and a second end;
a shaft assembly, the shaft assembly being connected to the second end and extending away from the second end; and
an extension, the extension being rotatably connected between the handle and the shaft assembly wherein the extension rotates between a closed position and an open position with the extension being positioned co-planar between the first end and the second end in the closed position and with the extension being perpendicularly positioned to the handle in the open position to increase a torque force applied to the shaft assembly in the open position.

12. The fastener according to claim 10, wherein the handle comprises an indent portion between the first end and the second end.

13. The fastener according to claim 10, wherein the extension is positioned in the indent portion in the closed position such that the extension and the handle form a continuous outer surface.

14. The fastener according to claim 13, wherein the continuous outer surface is free from discontinuities

15. A method of fastening, comprising:
positioning a handle and a shaft;
rotating an extension connected to the handle from a closed position to an open position; and
applying force to the extension in the open position to exert an increased torque to the shaft.

16. The method of fastening according to claim 15, wherein the extension is perpendicularly positioned to the handle in the open position.

17. The method of fastening according to claim 15, wherein the extension is co-planarly positioned with the handle in the closed position to form a continuous outer surface.

18. The method of fastening according to claim 15, further comprising rotating the extension to a partially open position.

19. The method of fastening according to claim 18, further comprising applying force to the extension in the partially open position.

20. The method of fastening according to claim 19, wherein the extension is angularly positioned with the handle in the partially open position.
